(19) United States
(12) Patent Application Publication
(10) Pub. No.: US 2004/0146619 A1
(43) Pub. Date: Jul. 29, 2004

(54) Hop acids as an antimicrobial agent for use in food processing facility

(76) Inventor: John Paul Maye, (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/666,461

(22) Filed: Sep. 19, 2003

Related U.S. Application Data
(60) Provisional application No. 60/412,517, filed on Sep. 19, 2002.

(51) Int. Cl. A23P 1/00; A23L 1/216

(52) U.S. Cl. 426/481

(57) ABSTRACT

A method of using hop acids as an antimicrobial agent for a food processing facility is described including delivering the hop acids in a biodegradable detergent for use in sanitizing a refrigerated food processing facility. The hop acids are mixed with the biodegradable detergent in an amount to inhibit certain types of microbial organisms. This method is particularly effective in combating Staphylococcus aureus and Listeria monocytogenes, two prevalent food pathogens.

### CROSS-REFERENCE TO RELATED APPLICATIONS

This application claims priority to U.S. Provisional Patent Application Serial No. 60/412,517, entitled HOP ACIDS AS AN ANTIMICROBIAL AGENT FOR A FOOD PROCESSING FACILITY, filed 19 Sep. 2002.

### BACKGROUND OF THE INVENTION

The present invention is directed to an organic food supplement and gram-positive bacteria capable of causing illness in humans and animals. In particular, the invention is directed to using hop extracts as antimicrobial agents used to sanitize food processing facilities.

Although there are a number of causes of food borne illnesses, the most common cause is bacteria related. Perishable foods contain nutrients that encourage bacteria to grow. These bacteria can produce toxins that cause illness. Over 90 percent of the food borne illnesses are caused by Staphylococcus aureus, Salmonella, Clostridium perfringens, Campylobacter, Listeria monocytogenes, Vibrio parahaemolyticus, Bacillus cereus, and Entero-pathogenic Escherichia coli.

Staphylococcus aureus is a spherical gram-positive bacteria. Some strains, when allowed to grow in foods, are capable of producing heat stable protein toxins that cannot be destroyed by cooking. A toxin dose of less than 1.0 micrograms in contaminated foods will produce symptoms of staphylococcal illness. Foods frequently associated with staphylococcal food poisoning include meat and meat products, poultry and egg products, egg, tuna, potato, and macaroni salads, and bakery products.

Listeria monocytogenes (“Listeria”) is a food borne pathogen that is rod-shaped and gram-positive. It is found virtually everywhere because of its ability to survive in diverse climates such as freezing, drying, heat, and refrigeration. The Center for Disease Control estimates that approximately 99 percent of Listeria infections are through food borne transmissions. Listeriosis is an especially serious health threat to pregnant women, newborns, the elderly, as well as those who are ill, such as people with AIDS or cancer.

In modern society, most foods, including everything from meat to ready to eat prepared foods are processed and handled in large and small food processing facilities. The potential for bacteria growth in these facilities is high and poses great risk to consumers. Different methods, including refrigeration and pasteurization have been used to slow bacterial growth and preserve freshness. However, bacteria like Listeria are resistant to refrigeration.

In order to sanitize them against food borne pathogens like Listeria, a number of different solvents and antimicrobial agents have been used to clean the different units in refrigerated food processing facilities. However, traditional antimicrobial cleaning products are highly alkaline solvents or corrosive materials. These products will erode the soft metals (aluminum and copper) that make up the units in the food processing facilities. Therefore, the units are not cleaned as often as they should be.

These and other limitations and problems of the past are solved by the present invention.

### BRIEF SUMMARY OF THE INVENTION

The present invention is a method of using hop acids as an antimicrobial agent for a food processing facility. The method includes delivering the hop acids in a biodegradable detergent for use in sanitizing the food processing facility. The hop acids are mixed with the biodegradable detergent in an amount to inhibit certain types of microbial organisms.

An advantage over the art is that the invention provides an organic antimicrobial agent that reduces the concentration of Staphylococcus aureus and Listeria monocytogenes without the damaging effects of traditional harsh cleaners. The invention will best be understood by reference to the following detailed description of the preferred embodiment. The discussion below is descriptive, illustrative and exemplary and is not to be taken as limiting the scope defined by any appended claims.

### DETAILED DESCRIPTION OF THE BEST MODE

The hop plant, Humulus lupulus, produces organic acids known as alpha acids (humulone) and beta acids (lupulone). These hop acids also include isomerized forms of alpha and beta acids, their reduced forms and salts. For example, beta acids include lupulone, colupulone, adlupulone as well as other analogs. Alpha acids include humulone, cohumulone, adhumulone, posthumulone, and prehumulone, as well as other analogs. They consist of a complex hexagonal molecule with several side chains, with ketone and alcohol groups. Each different humulone differs in the make-up of the side chain. Alpha acids are known to isomerize when exposed to heat to form isoalpha acids. An isomerized and reduced alpha acid, hexahydroisoalpha acids, is commonly used to flavor beer.

The introduction of low levels of a commercially available hop extract, HEXAHOP™ (9% Hexahydro-iso-alpha-acids (w/w)), into biodegradable detergents has been effective in reducing microbial activity. HEXAHOP™ is commercially available from BetaTec Hop Products, 5185 MacArthur Blvd., NW, Suite 300, Washington D.C. 20016. The biodegradable detergents are identified by trademark as industrial cleaners in the table below. The addition of a 2% weight by volume of HEXAHOP™ reduced the concentration of tested bacteria by 5.1 log reduction.

The following test procedure was utilized in the example set forth below. Test organisms obtained from American Type Culture Collection (ATCC), P.O. Box 1549, Manassas, Va. 20108, including Listeria monocytogenes ATCC # 984, Listeria monocytogenes ATCC # 19115, Listeria monocytogenes ATCC #51777, and Staphylococcus aureus, were individually placed in test solutions consisting of biodegradable detergents with and without HEXAHOP™ as an additive. Both the initial concentration and final concentration of bacteria were calculated to determine its inoculum value and the log₁₀ reduction factor. The final concentration was measured either after ten minutes of exposure or five minutes of exposure.

Table 1 shows that the addition of 2% by weight volume of HEXAHOP™ decreased the concentration of test organisms by orders of magnitude when compared to solutions that did not contain the HEXAHOP™.

TABLE 1
Time Kill Study Results Showing Effects of Hop Acids
on Industrial Cleaners

| Test | | Listeria | Listeria | Listeria | |
|---|---|---|---|---|---|
| Solution | | monocytogenes | monocytogenes | monocytogenes | Staphylococcus |
| and Usage | | ATCC # 19115 | ATCC # 51777 | ATCC # 984 | aureus (Test |
| Conc. | | (Test Organism) | (Test Organism) | (Test Organism) | Organism) |
| Abator | Initial | 5.6 | 5.9 | 3.7 | |
| 450-TE @ | Concentration | | | | |
| 4% | (log₁₀ cfu/ml) | | | | |
| Control No | | | | | |
| Hops | | | | | |
| | Final | 5.3 @ 10 | 6.2 @ 10 | 4.9 @ 10 | |
| | Concentration | minutes | minutes | minutes | |
| | (log₁₀ cfu/ml) | | | | |
| | and Exposure | | | | |
| | Time | | | | |
| | Log₁₀ | 0.3 | 0.3 | 1.2 increase | |
| | Reduction | | | | |
| Abator | Initial | 5.1 | 5.4 | 4.2 | |
| 450-TE @ | Concentration | | | | |
| 4% with | (log₁₀ cfu/ml) | | | | |
| 4% Hops | | | | | |
| | Final | 0.3 @ 5 minutes | 0.3 @ 5 minutes | 0.04 @ 5 minutes | |
| | Concentration | | | | |
| | (log₁₀ cfu/ml) | | | | |
| | and Exposure | | | | |
| | Time | | | | |
| | Log₁₀ | 4.8 | 5.1 | 4.1 | |
| | Reduction | | | | |
| Abator | Initial | 5.2 | 5.2 | | 5.2 |
| 450-TE @ | Concentration | | | | |
| 4% with | (log₁₀ cfu/ml) | | | | |
| 2% Hops | | | | | |
| | Final | 0.04 @ 5 minutes | 0.04 @ 5 minutes | | 0.04 @ 5 |
| | Concentration | | | | minutes |
| | (log₁₀ cfu/ml) | | | | |
| | and Exposure | | | | |
| | Time | | | | |
| | Log₁₀ | 5.1 | 5.1 | | 5.1 |
| | Reduction | | | | |
| Soil Off @ | Initial | 5.2 | 5.1 | | 6 |
| 4% | Concentration | | | | |
| Control | (log₁₀ cfu/ml) | | | | |
| No Hops | | | | | |
| | Final | 0.0 @ 5 minutes | 4 @ 5 minutes | | 5.8 @ 5 |
| | Concentration | | | | minutes |
| | (log₁₀ cfu/ml) | | | | |
| | and Exposure | | | | |
| | Time | | | | |
| | Log₁₀ | 5.2 | 1.1 | | 0.2 |
| | Reduction | | | | |
| Soil Off @ | Initial | 3.7 | 3.7 | | 5.6 |
| 4% with | Concentration | | | | |
| 2% Hops | (log₁₀ cfu/ml) | | | | |
| | Final | 0.04 @ 5 minutes | 0.04 @ 5 minutes | | 0.04 @ 5 |
| | Concentration | | | | minutes |
| | (log₁₀ cfu/ml) | | | | |
| | and Exposure | | | | |
| | Time | | | | |
| | Log₁₀ | 3.7 | 3.7 | | 5.5 |
| | Reduction | | | | |
| Liquid K @ | Initial | 4 | 5.3 | | 5.7 |
| 4% | Concentration | | | | |
| Control | (log₁₀ cfu/ml) | | | | |
| No Hops | | | | | |
| | Final | 0 @ 5 minutes | 3 @ 5 minutes | | 5 @ 5 |
| | Concentration | | | | minutes |
| | (log₁₀ cfu/ml) | | | | |
| | and Exposure | | | | |
| | Time | | | | |
| | Log₁₀ | 4 | 2.3 | | 0.7 |
| | Reduction | | | | |
| Liquid K @ | Initial | 4 | 4.8 | | 5.3 |
| 4% with | Concentration | | | | |
| 2% Hops | (log₁₀ cfu/ml) | | | | |
| | Final | 0.04 @ 5 minutes | 0.04 @ 5 minutes | | 0.04 @ 5 |
| | Concentration | | | | minutes |
| | (log₁₀ cfu/ml) | | | | |
| | and Exposure | | | | |
| | Time | | | | |
| | Log₁₀ | 3.9 | 4.8 | | 5.2 |
| | Reduction | | | | |
| CD 262 @ | Initial | 5.8 | 3.9 | | 6.4 |
| 4% | Concentration | | | | |
| Control | (log₁₀ cfu/ml) | | | | |
| No Hops | | | | | |
| | Final | 4.1 @ 5 minutes | 3.6 @ 5 minutes | | 4.9 @ 5 |
| | Concentration | | | | minutes |
| | (log₁₀ cfu/ml) | | | | |
| | and Exposure | | | | |
| | Time | | | | |
| | Log₁₀ | 1.7 | 0.3 | | 1.5 |
| | Reduction | | | | |
| CD 262 @ | Initial | 4.7 | 4.9 | | 5.3 |
| 4% with | Concentration | | | | |
| 2% Hops | (log₁₀ cfu/ml) | | | | |
| | Final | 0.04 @ 5 minutes | 0.04 @ 5 minutes | | 0.04 @ 5 |
| | Concentration | | | | minutes |
| | (log₁₀ cfu/ml) | | | | |
| | and Exposure | | | | |
| | Time | | | | |
| | Log₁₀ | 4.7 | 4.8 | | 5.2 |
| | Reduction | | | | |
| Chem | Initial | 4.6 | 5.2 | 4.9 | 5.6 |
| Station | Concentration | | | | |
| 6455 @ 4% | (log₁₀ cfu/ml) | | | | |
| Control | | | | | |
| No Hops | | | | | |
| | Final | 0.04 @ 5 minutes | 4.1 @ 5 minutes | 0.04 @ 5 minutes | 5.7 @ 5 |
| | Concentration | | | | minutes |
| | (log₁₀ cfu/ml) | | | | |
| | and Exposure | | | | |
| | Time | | | | |
| | Log₁₀ | 4.6 | 1.1 | 4.9 | 0 |
| | Reduction | | | | |
| Chem | Initial | 3 | 3.6 | | 5.3 |
| Station | Concentration | | | | |
| 6465 @ 4% | (log₁₀ cfu/ml) | | | | |
| with 2% | | | | | |
| Hops | | | | | |
| | Final | 0.04 @ 5 minutes | 0.04 @ 5 minutes | | 5.1 @ 5 |
| | Concentration | | | | minutes |
| | (log₁₀ cfu/ml) | | | | |
| | and Exposure | | | | |
| | Time | | | | |
| | Log₁₀ | 3 | 3.6 | | 0.2 |
| | Reduction | | | | |
| Spartan | Initial | 5.3 | 5.1 | | 6.4 |
| SC-200 @ | Concentration | | | | |
| 4% | (log₁₀ cfu/ml) | | | | |
| Control | | | | | |
| No Hops | | | | | |
| | Final | 3.3 @ 5 minutes | 5.3 @ 5 minutes | | 6.5 @ 5 |
| | Concentration | | | | minutes |
| | (log₁₀ cfu/ml) | | | | |
| | and Exposure | | | | |
| | Time | | | | |
| | Log₁₀ | 2 | 0 | | 0 |
| | Reduction | | | | |
| Spartan | Initial | 0.04 | 4.8 | | 4.9 |
| SC-200 @ | Concentration | | | | |
| 4% with | (log₁₀ cfu/ml) | | | | |
| 2% Hops | | | | | |
| | Final | 0.04 @ 5 minutes | 0.04 @ 5 minutes | | 0.04 @ 5 |
| | Concentration | | | | minutes |
| | (log₁₀ cfu/ml) | | | | |
| | and Exposure | | | | |
| | Time | | | | |
| | Log₁₀ | | 4.8 | | 4.9 |
| | Reduction | | | | |

Hop acids can be used in a variety of different ways related to the description above. Hop acids can be incorporated into food or food processing to control the concentration of microorganisms. Hop acids may also be incorporated into food packaging materials to control the concentration of microorganisms. In addition, hop acids can also be used in cooling towers to control the concentration of microorganisms.

The above description is illustrative and exemplary and is not to be taken as limiting the scope defined by any appended claims.

I claim:

1. A method of using hop acids as an antimicrobial agent for a food processing facility, comprising:
delivering the hop acids in detergents and cleaners for use in controlling microorganisms in food processing facility, wherein the hop acids are mixed with the biodegradable detergent in an amount to inhibit certain types of microbial organisms.

2. The method of claim 1, wherein the microbial organisms are Staphylococcus aureus and Listeria monocytogenes.

3. The method of claim 1, wherein the hop acids are hexahydroisoalpha acids.
